(19) United States
(12) Patent Application Publication
(10) Pub. No.: US 2014/0218455 A1
(43) Pub. Date: Aug. 7, 2014

(54) IMAGE FORMING APPARATUS

(71) Applicants: TOSHIBA TEC KABUSHIKI KAISHA, Tokyo (JP); KABUSHIKI KAISHA TOSHIBA, Tokyo (JP)

(72) Inventor: Masaki Ichikawa, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/164,541

(22) Filed: Jan. 27, 2014

(30) Foreign Application Priority Data
Feb. 1, 2013 (JP) 2013-018810

(51) Int. Cl. B41J 2/385

(52) U.S. Cl. CPC G03G 15/043
USPC 347/118

(57) ABSTRACT

An image forming apparatus comprises a first exposure unit, a first image carrier, a second exposure unit, a second image carrier and an exposure signal generation unit. The first exposure unit/The second exposure unit includes a given number of light-emitting elements which are linearly arranged, and changes a light emission amount of each light-emitting element in response to an image signal corresponding to a first color/a second color which can hardly be recognized in the change of the straight line state; and the exposure signal generation unit excludes a correction during exposure for reducing the influence of the change of the straight line state of each light-emitting element at the time when the second exposure unit emits the light.

### CROSS-REFERENCE TO RELATED APPLICATION

This application is based upon and claims the benefit of priority from Japanese Patent Application No. 2013-018810, filed Feb. 1, 2013, the entire contents of which are incorporated herein by reference.

### FIELD

Embodiments described herein relate to an image forming apparatus.

### BACKGROUND

In an image forming apparatus forming an image on a sheet, a general method of visualizing a latent image formed by irradiating a photoconductor with an image light using a developing material (developing agent) is known.

There exists an image forming apparatus which uses a LED (Light Emitting Diode) head as a device irradiating a photoconductor with an image light.

In the image forming apparatus using a LED head, a given number of LED elements corresponding to the resolution are linearly arranged, and a linear image extending in a horizontal scanning direction is formed. In a vertical scanning direction orthogonal to the horizontal scanning direction, the linear images extending in the horizontal scanning direction are formed in sequence at an interval determined in association with the resolution. That is, an output image determined by the quantity of pixels in the horizontal scanning direction (the element quantity of the LED element) and the number of images in the vertical scanning direction is formed.

### BRIEF DESCRIPTION OF THE DRAWINGS

FIG. 1 illustrates one example of an image forming apparatus according to an embodiment;

FIG. 2 illustrates one example of an image forming section of the image forming apparatus according to the embodiment;

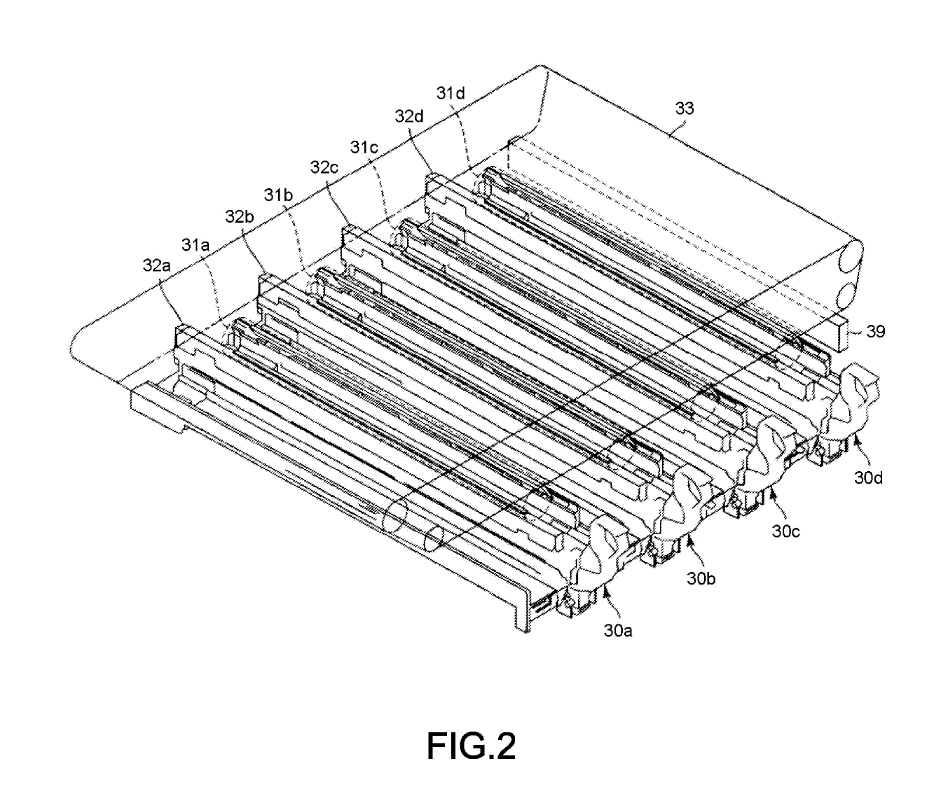

FIG. 3 illustrates one example (control block) of the image forming apparatus according to the embodiment;

FIG. 4 illustrates one example of a first correction (distortion amount) of the image forming apparatus according to the embodiment;

FIG. 5 illustrates one example of a second correction (inclination amount) of the image forming apparatus according to the embodiment;

FIG. 6 illustrates one example of inclination amount detection of the image forming apparatus according to the embodiment; and

FIG. 7 illustrates one example of a control method of the image forming apparatus according to the embodiment.

### DETAILED DESCRIPTION

In accordance with one embodiment, an image forming apparatus comprises a heating unit, a first conveyance unit, a second conveyance unit and a guide unit. The heating unit heats a sheet and a color material held by the sheet. The first conveyance unit conveys the sheet and the color material to the heating unit. The second conveyance unit conveys the sheet and the color material to the heating unit at a shorter conveyance distance compared with that of the first conveyance unit. The guide unit guides the sheet and the color material to any of the first and the second conveyance unit in such a manner that the sheet and the color material can be conveyed to the heating unit.

Hereinafter, embodiments are described with reference to accompanying drawings.

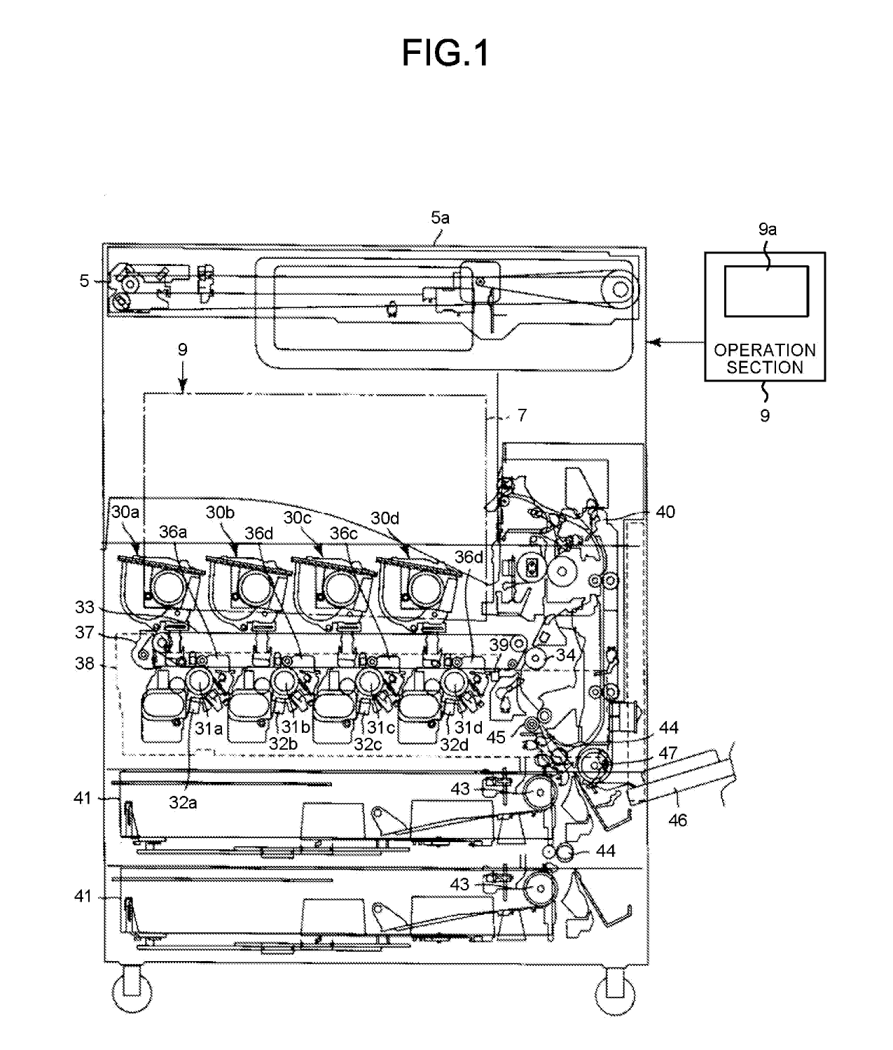

An image forming apparatus (multi-functional peripherals (MFP), hereinafter referred to as MFP in short) 1 shown in FIG. 1 at least comprises an image forming section 3, an image reading section 5 and a signal processing/operation control section (circuit board) 7. In addition, an operation section (display panel) 9 is arranged at a given position of the MFP 1.

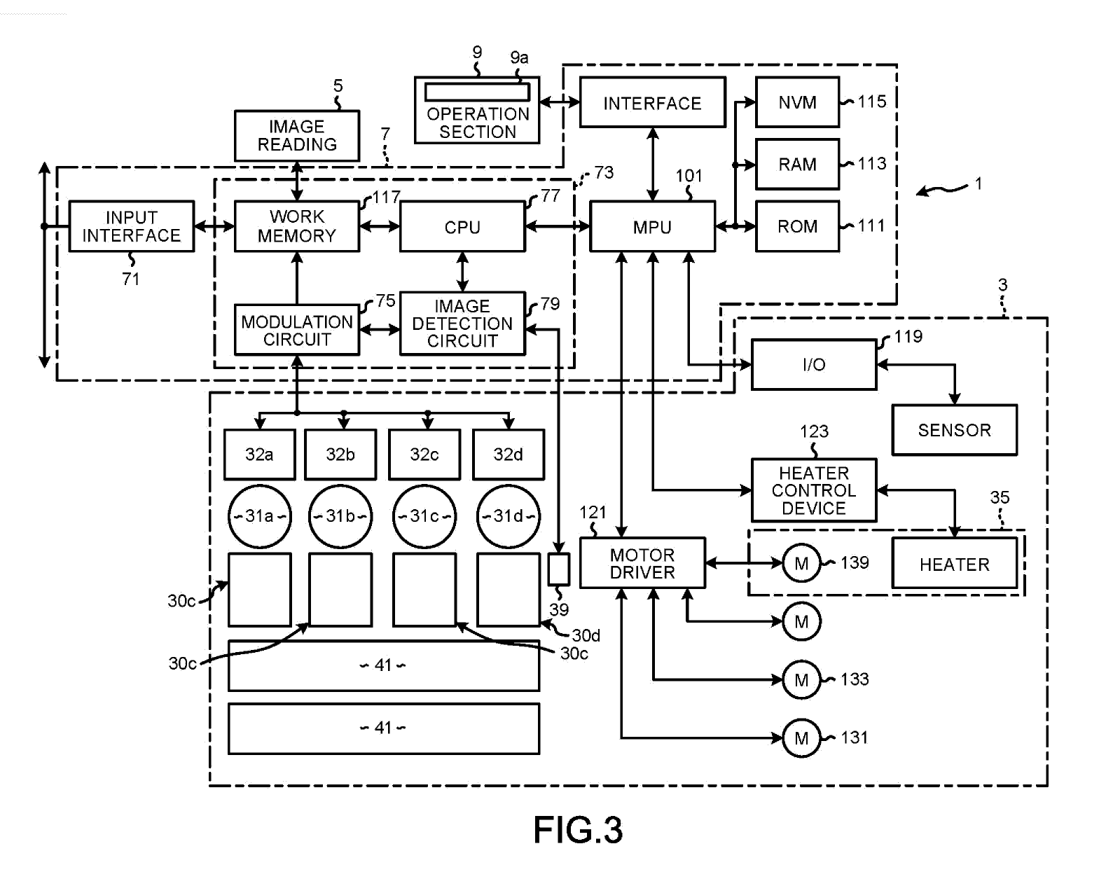

The image forming section 3 forms a visible image corresponding to image data on a sheet serving as a paper or a resin sheet. The image data may be, for example, the data generated by the image reading section 5, or the data from an external device. The data from an external device may be the data supplied by a storage (portable) medium such as a semiconductor memory and the like, or the data supplied by a supply source on a network through an interface 71 (refer to FIG. 3).

The image reading section 5 acquires a character or an image of a reading target as the brightness and darkness of a light, and generates image data corresponding to the brightness and darkness.

The image reading section 5 includes at least an original table (original glass) 5a, an illuminating device and an image sensor. The original (reading target) held by the original table 5a reflects an illumination light output by the illuminating device, and then the image sensor converts a reflected light (image information) into an image signal. The image sensor may be, for example, a CCD sensor or a CMOS (Complementary metal-oxide Semiconductor) sensor.

The signal processing/operation control section 7 converts the image signal generated by the image reading section 5 into image data suitable for the image formation based on the image forming section 3. As shown by the example in FIG. 3, the signal processing/operation control section 7 carries out, on the image signal from the image sensor, a given processing, for example, character specification, contour correction, color tone correction (color conversion, RGB→CMY, density), halftone (gradation), y characteristic (input density value to output density) and the like, for the output image (printout). The image signal and the image data are stored in a storage apparatus (not shown), for example, a hard disk drive (HDD), or a semiconductor memory which can be taken out from the MFP 1, and the like.

The image forming section 3 comprises first to fourth monochrome image forming stations (visible image forming sections) 30a, 30b, 30c and 30d, and first to fourth exposure devices 32a, 32b, 32c and 32d. Each image forming station 30a, 30b, 30c and 30d has a photoconductive drum (image carrier) 31a, 31b, 31c and 31d for generating and holding a latent image corresponding to an image light, that is, the exposure light from the exposure devices 32a, 32b, 32c and 32d, a development device and a transfer device (primary transfer section).

The image forming section 3 further comprises an intermediate transfer belt (visible image holding (primary transfer) section) 33, a sheet transfer device (secondary transfer section) 34, a fixing device 35, first to fourth waste toner collection mechanisms 36a, 36b, 36c and 36d, an intermediate transfer belt cleaner 37 and a waste toner recovery device 38 and the like.

Each monochrome image forming station (visible image forming section) 30a, 30b, 30c and 30d irradiates each photoconductive drum 31a, 31b, 31c and 31d of which the potential changes in response to the intensity of the image light with the exposure light, that is, the image light irradiated by the first to fourth exposure devices 32a, 32b, 32c and 32d.

The image forming section 3 further includes an automatically duplex unit (ADU) 40, at least one sheet cassette 41 and a paper feed mechanism 43 attached to each sheet cassette, a conveyance mechanism 44 and a aligning mechanism 45. In addition, a manual feeding tray 46 and a paper feed mechanism 47 attached to the manual feeding tray are positioned at the front stage of the aligning mechanism 45. Further, a plurality of stages of sheet cassettes 41 may be stacked and used.

The first to fourth exposure devices 32a, 32b, 32c and 32d include a LED head (LED element array), respectively, and outputs the image light obtained by converting the image data from the image processing section 73 of the signal processing/operation control section 7 into the intensity of light.

The image lights output by the first to fourth exposure devices 32a, 32b, 32c and 32d form latent images on the photoconductive drums of the first to fourth image forming stations 30a, 30b, 30c and 30d, respectively. That is, the potentials of the photoconductive drums 31a, 31b, 31c and 31d of the image forming stations 30a, 30b, 30c and 30d change in response to the intensity of the image light from the LED head, and the potential difference becomes the latent image (electrostatic image).

Each image forming station 30a, 30b, 30c and 30d forms a visible image in C (cyan), M (magenta), Y (yellow), K (black) color, respectively. The development device supplies a toner for the latent image mentioned above held by each photoconductive drum 31a, 31b, 31c and 31d to develop the latent image. The transfer device transfers the toner image (visible image) held by each photoconductive drum 31a, 31b, 31c and 31d to the intermediate transfer belt 33.

In addition, the arrangement (position) of each image forming station 30a, 30b, 30c and 30d, that is, the order of the colors is determined in response to the image forming process and the characteristic of the toner.

The intermediate transfer belt 33 holds and conveys the toner image (visible image) formed by each station 30a, 30b, 30c and 30d.

The sheet transfer device 34 transfers the toner image conveyed by the intermediate transfer belt 33 to a sheet (paper).

The fixing device 35 fixes the toner, that is, the toner image transferred from the intermediate transfer belt 33 to the sheet by the sheet transfer device 34 on the sheet.

The waste toner collection mechanism 36 collects the residual non-transferred toner (residual toner) which is left (on each photoconductive drum) without being transferred from the photoconductive drum to the intermediate transfer belt 33, and is removed by the cleaner nearby the transfer device (primary transfer section) of each station 30a, 30b, 30c and 30d in such a manner that the toner can be recovered (held) by the waste toner recovery device 38.

The intermediate transfer belt cleaner 37 collects the residual non-transferred toner (residual toner) which is left on the intermediate transfer belt 33 without being transferred from the intermediate transfer belt 33 to the sheet nearby the sheet transfer device (secondary transfer section) 34 in such a manner that the toner can be recovered (held) by the waste toner recovery device 38.

The waste toner recovery device 38 recovers the residual non-transferred toner collected by the waste toner collection mechanism 36 and the residual non-transferred toner collected by the intermediate transfer belt cleaner 37.

The paper feed mechanism 42 picks up a sheet from the sheet cassette 41 at a given timing corresponding to the image forming operation in each image forming station 30a, 30b, 30c and 30d. The sheet from the cassette 41 is conveyed by the conveyance mechanism 44 to a transfer position where the intermediate transfer belt 33 and the sheet transfer device 34 are contacted. The timing when the sheet is conveyed to the transfer position (the position where the intermediate transfer belt 33 and the sheet transfer device 34 are contacted) is set by the aligning mechanism 45 in association with the image forming operation in each image forming station 30a, 30b, 30c and 30d.

The fixing device 35 heats the sheet and the toner electrostatically stuck to the sheet, and applies a pressure to fix the toner on the sheet.

The sheet on which the toner (toner image) is fixed by the fixing device 35 is conveyed, as the output image (printout), to the space between the image reading section 5 and the image forming section 3, or the ADU (automatically duplex unit) 40.

The ADU 40 inverts the front and back side of the sheet such that the toner can be transferred to the second surface serving as the back surface of the first surface of the sheet on the first surface of which the toner image is stuck tightly, and conveys (positions) the side-inverted sheet to the aligning mechanism 45.

As shown in the example in FIG. 3, the signal processing/operation control section 7 includes an image input section (input interface) 71, an image processing section 73, a modulation circuit (exposure signal generation section) 75, a CPU (Central Processing Unit) 77, an image detection circuit (exposure timing detection section) 79 and the like.

The input interface 71 receives the image data supplied from, for example, an external device such as a personal computer (PC) and the like, or supplied via a network and the like.

The image processing section 73 carries out a given processing such as the aforementioned character specification, contour correction, color tone correction, y characteristic and the like on the image signal generated by image reading section 5 or the image data from the input interface 71.

The exposure signal generation section 75 converts the image data processed by the image processing section 73 into a modulation signal (exposure signal) for the use as the exposure light from the first to fourth exposure devices 32a, 32b, 32c and 32d.

The CPU 77 controls the image data processing in the image processing section 73.

The image detection circuit (exposure timing detection section) 79 detects, based on the output from the image sensor 39, the inclination (that is, can be managed as the exposure timing) of the image of each color formed in each image forming station 30a, 30b, 30c and 30d.

The signal processing/operation control section 7 further comprises a main processing unit (MPU) 101 controlling the whole operations of the MFP 1 which includes the image processing section 73 (CPU 77), the image forming section 3 and the image reading section 5, and controls the image reading operation, the image forming operation and the like.

The MPU 101 controls each section (component) of the MFP 1 according to the control input from the control panel (operation section) 9 receiving an input of an instruction (operation) on the MFP 1.

The operation section 9 has a display section 9a. The display section 9a displays the state of each section of the MFP 1 and the like through a display (user interface) known as, for example, a character string or a symbol (pictogram, pictogram/icon, and icon) and the like. The display section 9a further functions as a touch panel, and displays the aforementioned display and the like according to the reception of an instruction (control) input from a user, the display of the received input and the control of the MPU 101.

The signal processing/operation control section 7 further includes a ROM (Read Only Memory) 111, a RAM (Random Access Memory) 113, a NVM (Non-volatile Memory) 115, a page memory (work memory) 117 used in the image processing in the image processing section 73, an I/O port 119 for inputting the output and the like from the sensor of each section into the MPU 101, and the like.

The MPU 101 is connected with a motor driver 121 controlling the rotation of any motor 131, 133 . . . 139. The motor 131 drives, for example, the first to fourth image forming stations 30a, 30b, 30c and 30d, the intermediate transfer belt 33 and the like. The motor 133 drives the components relating to the conveyance of the sheet from the cassette to the fixing device 35 (ADU 40), for example, the paper feed mechanism 42, the conveyance mechanism 44, the aligning mechanism 45 and the sheet transfer device 34, and the like. In addition, the fixing device 35 is driven by, for example, the motor 139 independently.

The MPU 101 is further connected with a heater control device 123 driving a heater setting the temperature of the fixing device 35.

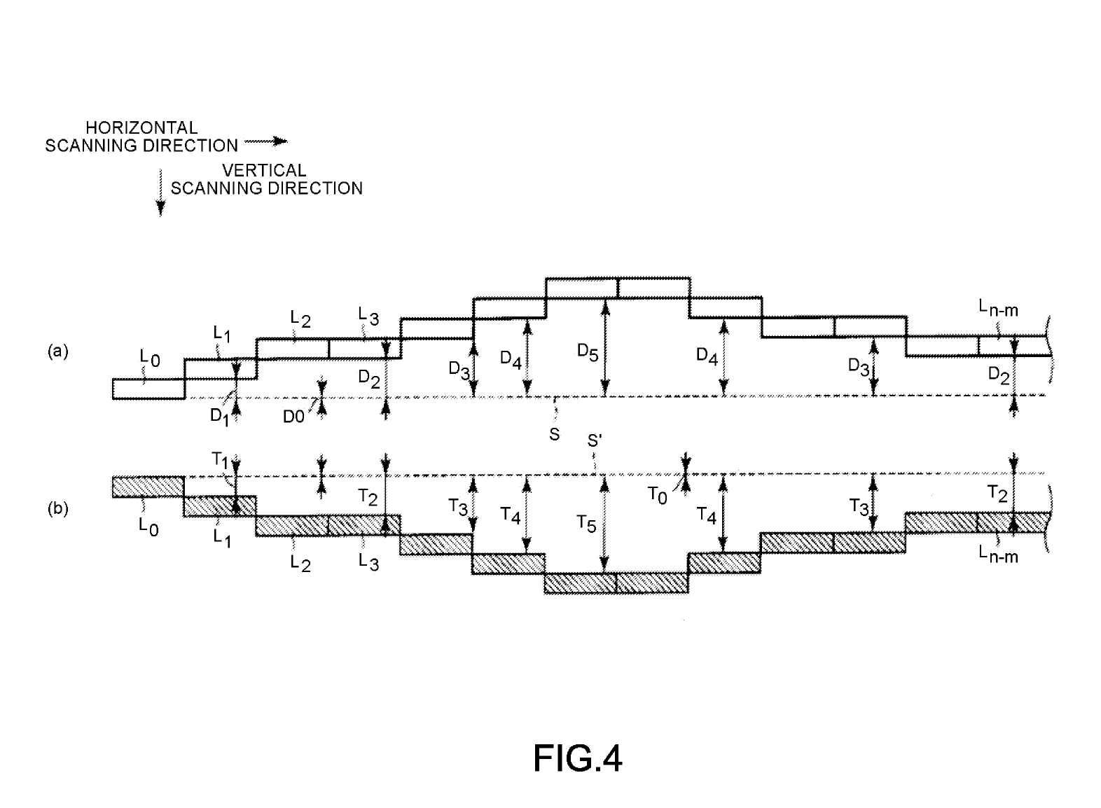

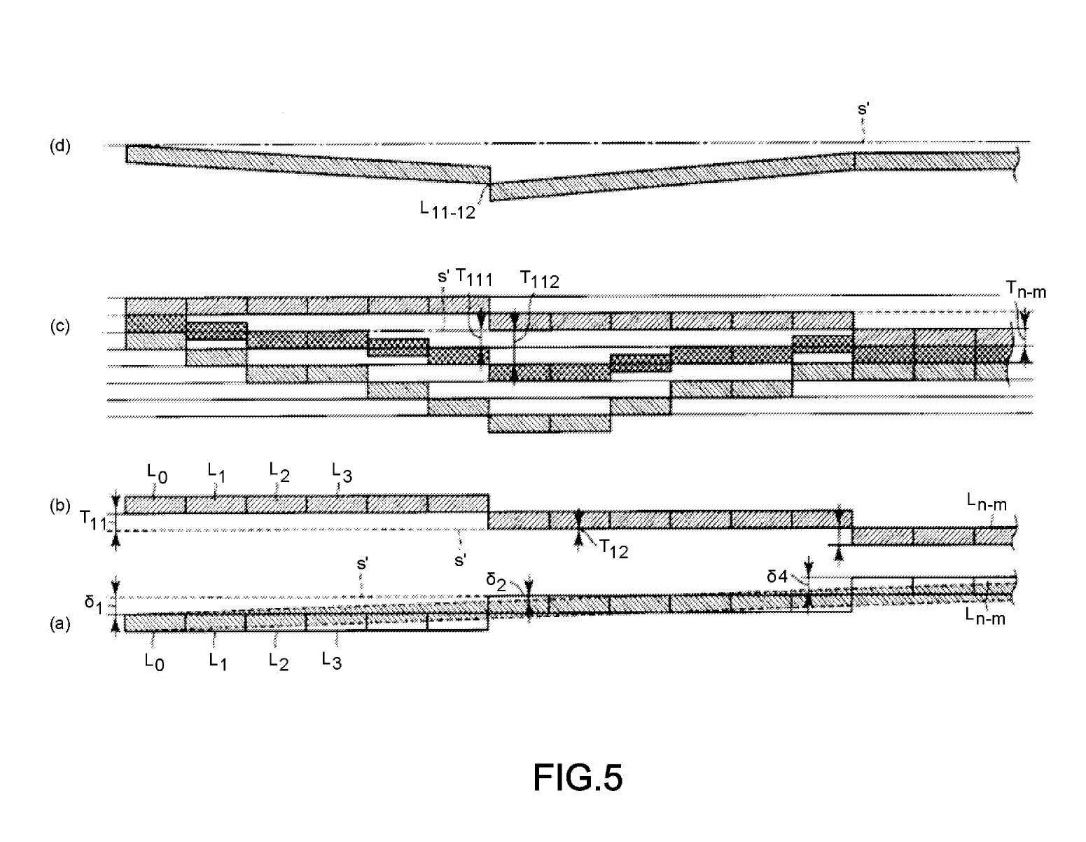

The exposure signal generation section 75 corrects the deviation of the image corresponding to the image light (exposure light) output by the first to fourth exposure devices 32a, 32b, 32c and 32d and the linearity, which will be described in the following description with reference to FIG. 4 and FIG. 5.

As shown in FIG. 4(a), the LED element array of the LED head included by any exposure device 32a, 32b, 32c and 32d has position deviation in vertical scanning direction. That is, the intervals between a reference line (straight line) S and each LED element are different from each other, for example, the position deviation (hereinafter referred to as distortion amount) in a range from D0 to D5 exists in each element L0˜Ln-m˜Ln (n and M are integers).

As shown in FIG. 4(b), in order to compensate the influence of the distortion errors D0˜D5 in each LED element L0˜Ln-m˜Ln, there are provided timing correction values (correction amount A) T0˜T5 serving as correction values for a reference time S. The timing correction values T0˜T5 are managed for each LED head by a portable medium (external storage apparatus) or a storage element (internal memory) integrated with a LED head and the like.

FIG. 5 shows an example of correcting the inclination of the linear image occurring in a case where the LED head, when incorporated into the image forming apparatus, is nonparallel with a horizontal scanning direction in design.

The linear image may become nonparallel with the horizontal scanning direction even in a case where the image is formed using the image signal which is corrected in the vertical scanning direction by the exposure signal generation section 75 using the correction values T0˜T5 (refer to FIG. 4(b)) of each LED head. That is, inmost cases, the photoconductive drum 31(a˜d) and the exposure device 32(a˜d) are nonparallel in each image forming station 30a, 30b, 30c and 30d.

Therefore, generally, the deviation (inclination amount) in the vertical scanning direction is corrected in the image signal supplied for the LED head (exposure device).

That is, as to the linear image information which is shown by the dotted line in FIG. 5(a) and is supposed to be output, the image data which corresponds to one line in the horizontal scanning direction and spans multiple lines is read from the work memory (image memory/page memory). More specifically, in FIG. 5(a), the image data at the position of δ1 from the reference line S, the image data at the position of δ2 from the reference line S and the image data at the position of δ3 from the reference line S are read in such a manner that the linear image information is linearly interpolated.

As shown in FIG. 5(b), in order to compensate the influence of the position deviation (inclination amount) δ1˜δ3 in each LED element L0˜Ln-m˜Ln in the LED head, there are prepared timing correction values (correction amount B) T11˜T13 serving as correction values for the reference time S′.

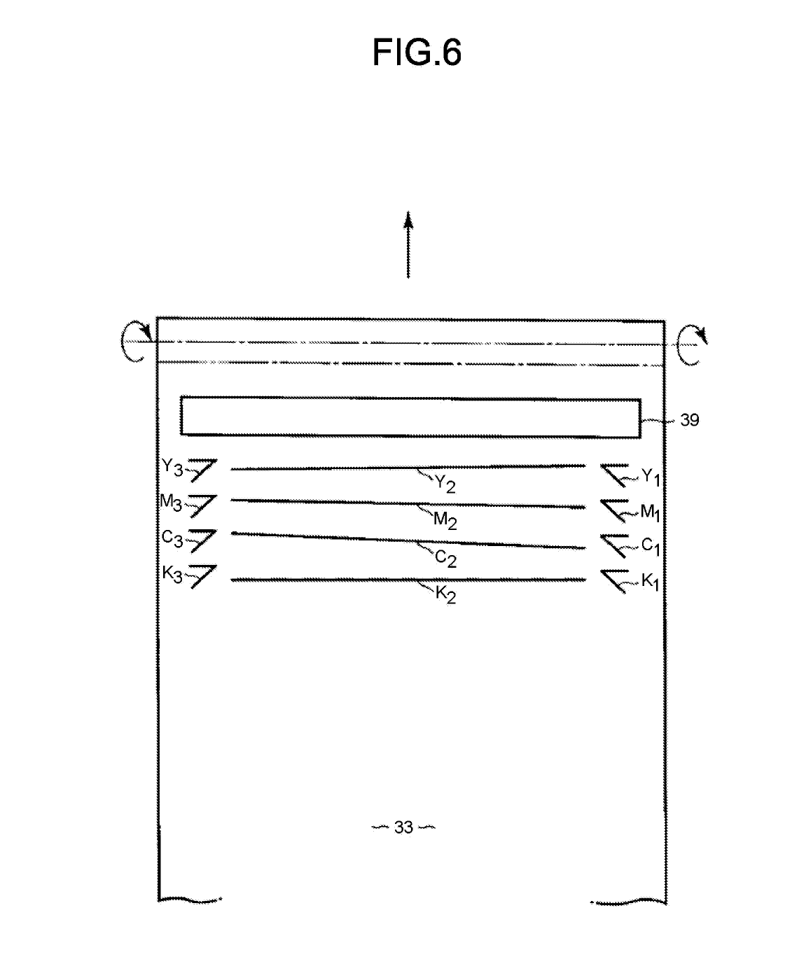

One example of the timing correction values T11˜T13 is shown in FIG. 6. Test pattern images Y1˜Y3, M1˜M3, C1˜C3 and K1˜K3 which move together with the movement of the belt surface (image holding surface) of the intermediate transfer belt 33 are detected by the image sensor 39, and the output thereof is calculated by comparing a reference value and a color component in the image detection circuit 79.

FIG. 5(c) shows one example of the timing correction values (synthesized correction amount C) obtained by synthesizing the timing correction values (correction amount A) T1˜T5 shown in FIG. 4(b) with the timing correction values (correction amount B) T11˜T13 shown in FIG. 5(b), and synthesizing (adding) the position deviation in the vertical scanning direction of each LED element shown in FIG. 4(a) with the mutual inclination amount of the LED head-photoconductive drum shown in FIG. 5(a).

FIG. 5(d) illustrates an example of forming a linear image using the timing correction values T001˜Tn-m shown in FIG. 5(c).

From FIG. 5(d), in a case where the amount of the deviation amount correction (linear interpolation) is above one line amount in the vertical scanning direction, like the connection part (change point of the pixel read in the vertical scanning direction) between timing correction values T111 and T112, it can be recognized as the deviation (stage deviation) of one line amount in the output image. For example, in an image having a resolution of 600 dpi (dots per inch), the interval of one line is 42 μm, and can be recognized by human eyes. In addition, seeing from color category, it is particularly easy to recognize the stage deviation of a K (black) color.

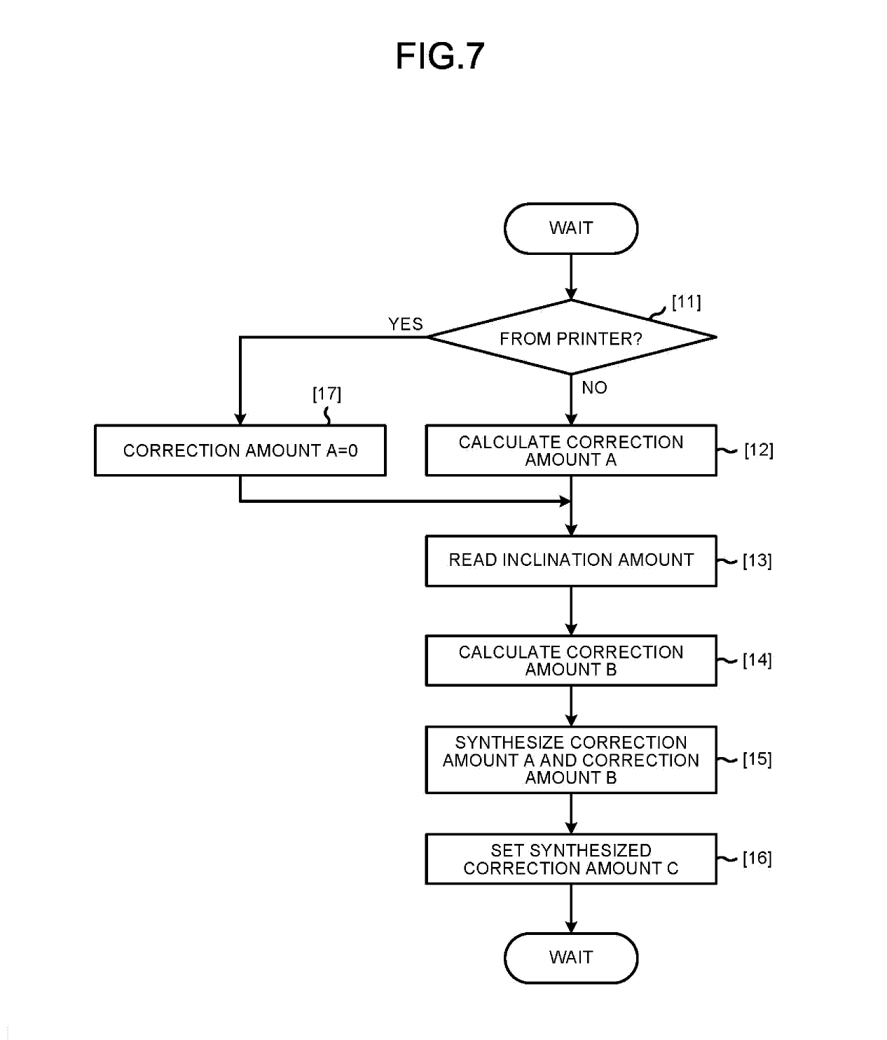

Therefore, as to an image of parallel narrow straight lines (ruled lines or tables) serving as an image of a color which can be easily recognized by human eyes, it is preferred to exclude the correction on the position deviation in the vertical scanning direction of the LED element shown in FIG. 4(b) according to the classification which will be described below with reference to FIG. 7.

In addition, in the practical printing (image formation and output to a sheet), it is obvious for a file (image data) containing a table or a graph created by an application soft installed in a PC (Personal Computer) and the like.

Further, as stated above, as it is particularly easy to recognize the stage deviation of a K (black) color, it is preferred to exclude the correction for the K color in case where a printing source (an image data supply destination) is printer output different from copy or scanning.

That is, as described in terms of software in FIG. 7, it is detected whether or not the image data is printer output (for example, supplied from a PC) [11]. If the image data is printer output (YES in [11]), the correction amount A is set to 0 (no correction) [17].

If the image data is anything excluding the printer output, for example, the copy or scanning supplied from the image reading section 5 (NO in [11]), the correction amount A is calculated [12].

Next, using the methods shown in FIG. 5(a) and FIG. 5(b), the test pattern images Y1˜Y3, M1˜M3, C1˜C3 and K1˜K3 which move together with the movement of the belt surface (image holding surface) of the intermediate transfer belt 33 are detected by the image sensor 39, and the inclination amount of the LED head-photoconductive drum is read [13].

Next, the correction amount B is calculated according to the read inclination amount [14].

Hereinafter, the correction amount A and the correction amount B are synthesized using the method shown in FIG. 5(c) [15], then the synthesized correction amount C is set [16].

That is, in a case of carrying out printing different from the printer output:

as to the distortion amount (a target of the correction amount A), the distortion amount is calculated for each Y/M/C/K color, the correction amount A corresponding to the calculated distortion amount is set, and then the correction is carried out for each color;

as to the inclination amount (a target of the correction amount B), a position alignment pattern is printed using the method shown in FIG. 6, the inclination amount for the K color is detected by the image sensor 39, and then the correction of the Y/M/C color is carried out based on the inclination amount of the K color.

On the other hand, in a case of carrying out printing of printer output:

as to the distortion amount, the distortion amount is calculated for each Y/M/C color, the correction amount A corresponding to the calculated distortion amount is set, and then the correction is carried out for each color except the K color. That is, the correction is not carried out for the K color;

as to the inclination amount, a position alignment pattern is printed, the inclination amount for the K color is detected by the image sensor 39, and then the correction of the Y/M/C color is carried out based on the inclination amount of the K color.

By establishing such a correspondence, the K (black) color can be easily noticed (recognized) in a case where slight distortion occurs in the linear image due to the variation during manufacturing of the LED head (exposure device), and the stage deviation of one line amount is prevented.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a first exposure unit configured to include a given number of light-emitting elements which are linearly arranged, and change a light emission amount of each light-emitting element in response to an image signal corresponding to a first color which can hardly be recognized in the change of the straight line state;
a first image carrier configured to hold an image corresponding to the light emission amount of the light from each light-emitting element of the first exposure unit;
a second exposure unit configured to include a given number of light-emitting elements which are linearly arranged, and change a light emission amount of each light-emitting element in response to an image signal corresponding to a second color which can be easily recognized in the change of the straight line state;
a second image carrier configured to hold an image corresponding to the light emission amount of the light from each light-emitting element of the second exposure unit; and
an exposure signal generation unit configured to exclude a correction during exposure for reducing the influence of the change of the straight line state of each light-emitting element at the time when the second exposure unit emits the light.

2. The image forming apparatus according to claim 1, wherein
a correction during exposure for reducing the influence of the change of the straight line state of each light-emitting element is excluded at the time when the second exposure unit emits the light in a case where a supply source of the image signal is an apparatus or application which can output an image signal including an image signal accompanied with parallel lines or ruled lines.

3. The image forming apparatus according to claim 1, wherein
a correction during exposure for reducing the influence of the change of the straight line state of each light-emitting element is excluded at the time when the second exposure unit emits the light in a case where image data corresponding to the image signal is an application outputting an image signal including an image signal accompanied with parallel lines or ruled lines.
